(19) United States
(12) Patent Application Publication
(10) Pub. No.: US 2004/0142233 A1
(43) Pub. Date: Jul. 22, 2004

(54) Battery holder

(76) Inventors: Noel S. Park, San Jose, CA (US); Derek Park, San Jose, CA (US)

Correspondence Address: Noel S. Park, 1150 Wunderlich Drive, San Jose, CA, 95129, US

(21) Appl. No.: 10/701,124

(22) Filed: Nov. 4, 2003

(30) Foreign Application Priority Data
Nov. 4, 2002 (KR) 2002-67739

(51) Int. Cl. H01M 2/10

(52) U.S. Cl. 429/100

(57) ABSTRACT

Battery holder (100) consists of elastic bands (106a, 106b, 106c, 106d) and battery support plates (105a, 105b) on which terminal contacts (102a, 102b) are affixed. Battery (90) is inserted into said battery holder (100) between the battery support plates (105a and 105b) and held by elastic bands (106a, 106b, 106c, 106d) so that a negative battery electrode (109a) mates a negative terminal contact (102a) and a positive battery electrode (109b) mates a positive terminal contact (102b). The battery's position expands the elastic bands and, therefore, exerts tension between the battery support plates (105a, 105b) and the battery (90) so that the expanded battery holder maintains proper contact between the battery electrodes (109a, 109b) and the terminal contacts (102a, 102b).

### BACKGROUND OF THE INVENTION

(a) Field of the Invention

The present invention relates generally to a battery holder, and more particularly to a new battery holder structure using elastic materials so that the battery holder can be used interchangeably for the various shapes and types of batteries.

(b) Description of the Prior Art

The structure of a conventional battery holder, as shown in FIG. 1, is pre-defined by the type of battery the holder is designed for. The conventional battery holder 4 consists of a plastic case 1, a terminal contact 2 affixed on both sides of the plastic case, and a spring attached to the terminal contacts. Such a conventional battery holder has a rigid case so that it can accommodate the only battery which can fit into the shape. Therefore, the conventional battery holder cannot hold multiple types of batteries. In addition, when the battery holder is built into the electronic device, the rigid shape makes the improvement of the industrial design of the target electronic device more difficult.

### SUMMARY OF THE INVENTION

The primary object of the present invention is to redefine battery charge options by providing an elastic battery holder that can accommodate various battery types with minimum holding space, especially useful for battery charger/discharger applications. In order to achieve the objective, the current invention utilizes elastic bands, attached to a battery support plate as a means for holding a battery while terminal contacts for making electrical contacts with the battery electrodes are affixed on the battery support plate.

The elastic band is formed from natural rubbers, synthetic rubbers, thermoplastic elastomers, elasticized fabrics, and blends thereof such that the elastic band exerts the right pressure between the terminal contact and battery electrode when the battery is inserted into the battery holder. Therefore, the current invention battery holder not only provides a universal battery holder for the variously shaped and sized batteries, but also minimizes the storage space as well as the cost of the battery holder by simplifying the battery holder structure.

### BRIEF DESCRIPTION OF THE DRAWINGS

The foregoing and other features and advantages of the present invention will be more clearly understood from the following detailed description and the accompanying drawings, in which,

FIG. 1 is a perspective view of the conventional battery holder.

FIG. 2 is a perspective view of the elastic battery holder for the axial-type battery with two terminal embodiments of the present invention.

FIG. 3 is a perspective view of the elastic battery holder, with the battery inserted, for the axial-type battery with two terminal embodiments with two terminal embodiments of the present invention.

FIG. 4 is a perspective view of the elastic battery holder with a dual terminal contact with a barrier wall between adjacent terminal contacts.

FIG. 5 is a perspective view of the elastic battery holder, with the battery inserted, and with a dual terminal contact having a barrier wall between adjacent terminal contacts.

FIG. 6 is a perspective view of the elastic battery holder with a single battery support plate and a closed loop elastic band.

FIG. 7 is a perspective view of the elastic battery holder, with an inserted battery, and with a single battery support plate and a closed loop elastic band.

FIG. 8 is a perspective view of the elastic battery holder similar to FIG. 2 but with a clip-on terminal contact. FIG. 9 is a perspective view of the elastic battery holder, with an inserted battery, similar to FIG. 3 but with a clip-on terminal contact.

FIG. 10 is a perspective view of the elastic battery holder similar to FIG. 4 but with a clip-on terminal contact.

FIG. 11 is a perspective view of the elastic battery holder, with an inserted battery, similar to FIG. 5 but with a clip-on terminal contact.

FIG. 12 is a perspective view of the elastic battery holder similar to FIG. 2 but with an extended cylindrical side wall.

FIG. 13 is a perspective view of the elastic battery holder, with an inserted battery, similar to FIG. 3 but with an extended cylindrical side wall.

FIG. 14 is a perspective view of the elastic battery holder similar to FIG. 4 but with an extended rectangular side wall.

FIG. 15 is a perspective view of the elastic battery holder, with an inserted battery, similar to FIG. 5 but with an extended rectangular side wall.

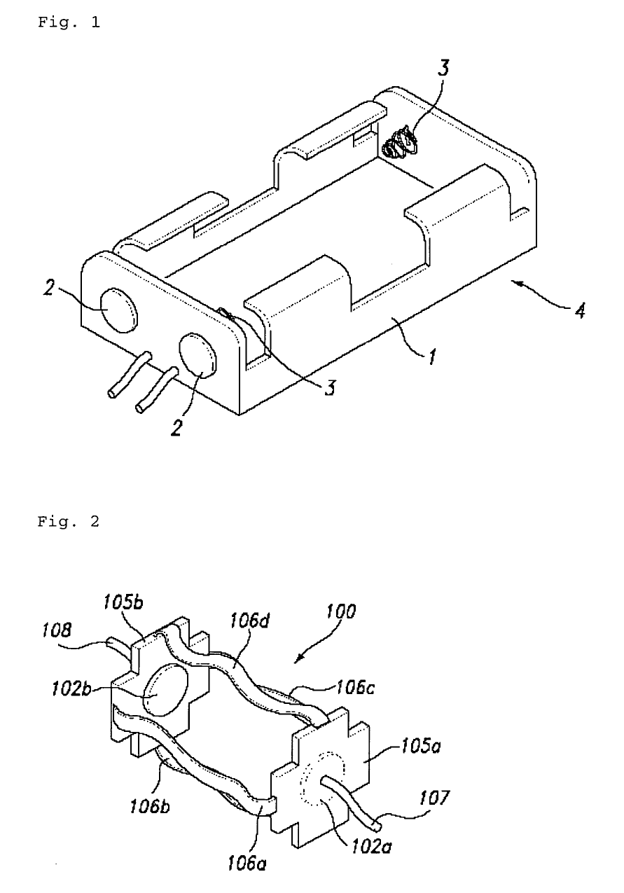

### DETAILED DESCRIPTION OF THE PREFERRED EMBODIMENT

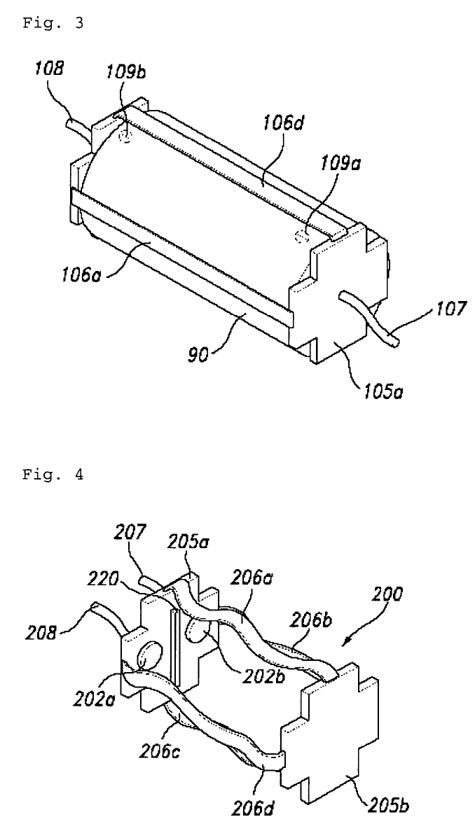

As shown in the accompanying drawings, the battery holder of the present invention essentially comprises an elastic band and a terminal contact affixed on a battery support plate. For the case of axial-type dry cell battery (90), battery holder (100) consists of non-conductive plastic battery support plates (105a, 105b) having multiple rubber elastic bands (106a, 106b, 106c, 106d) attached evenly to both battery support plates. Battery support plates (105a, 105b) and elastic bands (106a, 106b, 106c, 106d) are used for inserting and holding a battery (90) within. Terminal contact (102a) is affixed on said battery support plate (105a) and terminal contact (102b) is affixed on said battery support plate (105b). Said terminal contact (102a) connects to a negative lead wire (107) penetrated through said battery support plate (105a) and said terminal contact (102b) connects to a positive lead wire (108) penetrated through said battery support plate (105b). As shown in FIG. 3, said battery holder (100), upon insertion of a battery (90) between the battery support plates (105a, 105b) and the elastic bands, with a negative battery electrode (109a) mating a negative terminal contact (102a) and a positive battery electrode (109b) mating a positive terminal contact (102b), expands the elastic bands (106a, 106b, 106c, 106d). The tension between the battery support plate and battery ensures that the expanded battery holder maintains proper contact between battery electrodes (109a, 109b) and terminal contacts (102a, 102b).

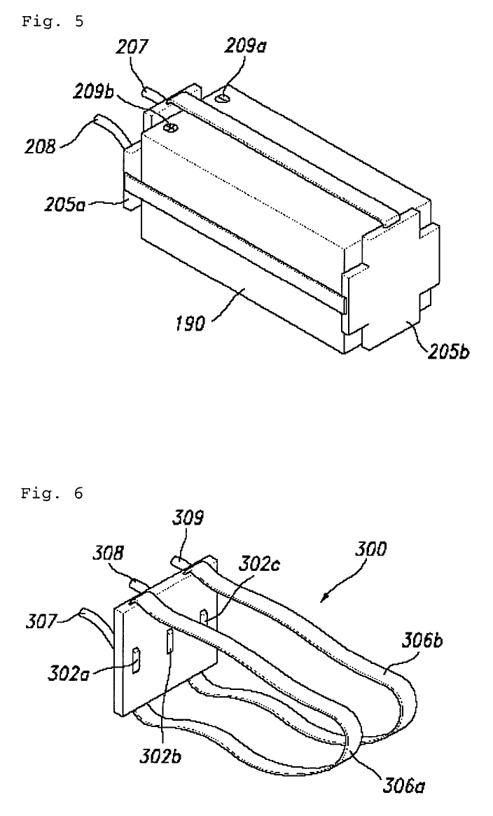

FIG. 4 shows another embodiment of the battery holder (200) with non-conductive plastic battery support plates (205a, 205b) having multiple rubber elastic bands (206a, 206b, 206c, 206d) attached evenly to both battery support plates. Said battery support plates (205a, 205b) and said elastic bands (206a, 206b, 206c, 206d) are used for inserting and holding a battery (190) within. On said battery support plate (205a), two terminal contacts (202a, 202b) are affixed. Said terminal contacts (202a, 202b) connect to positive lead wire (207) and negative lead wire (208), each of which is penetrated through the battery support plate. Where there is more than one terminal contact on a battery support, as in FIG. 4, a barrier wall can be erected between two adjacent terminal contacts to prevent an electrical shortage of battery electrodes during battery insertion and removal. The other battery support plate (205b) does not have terminal contacts and provides battery support function only. As shown in FIG. 5, said battery holder (200), upon insertion of a battery (190) between the battery support plates and the elastic bands, expands the elastic bands and exerts tension between the battery support plates (205a, 205b) and battery (190) within the battery holder so that the expanded battery holder maintains proper contact between battery electrodes (209a, 209b) and terminal contacts (202a, 202b). This example invention can be used for a battery with positive and negative electrodes in one side.

FIG. 6 and FIG. 7 show another embodiment of the present invention. As shown in FIG. 6, a battery holder (300) has elastic bands (306a, 306b) attached to a battery support plate (305). Each of the said elastic bands forms a closed loop by attaching both ends of the elastic band (306a) onto the single battery support plate (305). Said battery support plate (305) and said elastic bands (306a, 306b) are for inserting and holding a battery (290) within. Each of the three terminal contacts (302a, 302b, 302c) are embodied on said battery support plate (305) and connected to each of three lead wires (307, 308, 309) respectively. This type of construction can be used in multi-voltage battery types. For example, a battery pack (290) with three individual 3V cells connected in series and forming three terminal contacts on one side of the battery, can be controlled to become either 6V or 9V battery by selectively turning on/off the lead wires (307, 308, 309). If the lead wire (308) is off and the lead wires (307, 309) are on, the battery supplies 9V power and if the lead wire (308) is on and one of the lead wires (307, 309) is off, the battery supplies 6V power.

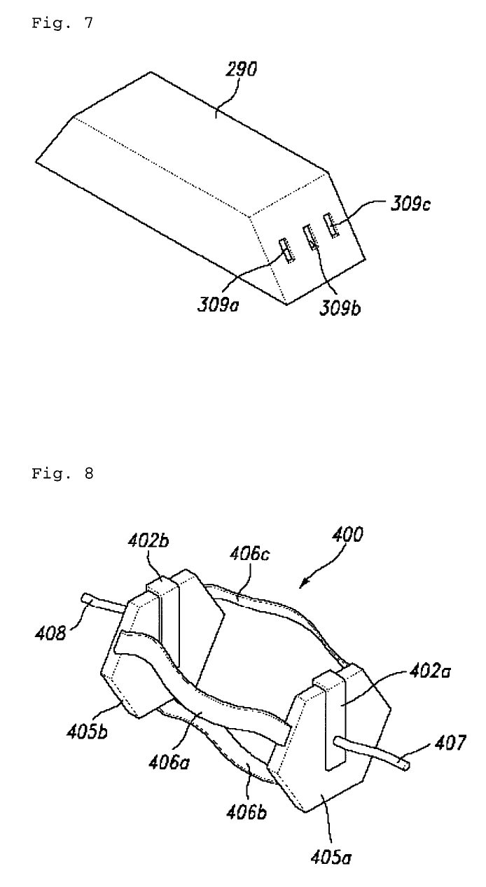

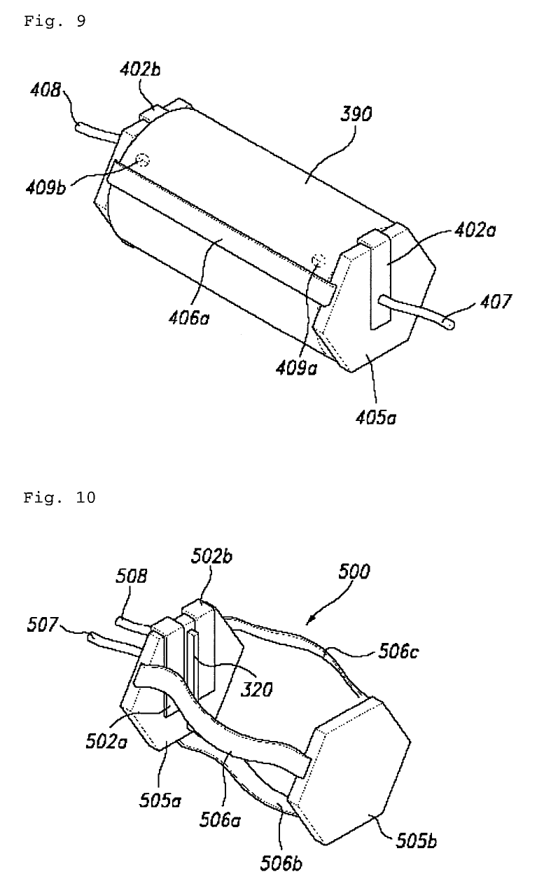

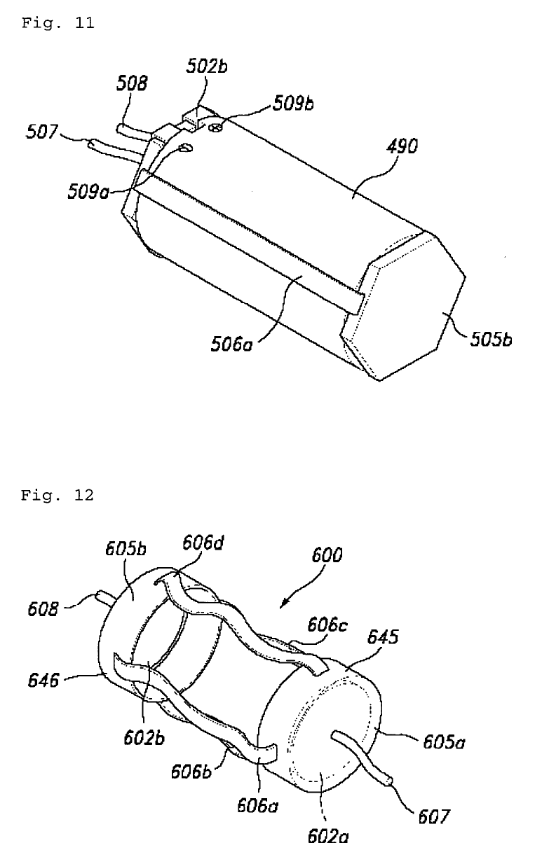

FIG. 8 shows another embodiment of the present invention which is very similar to FIG. 2 but affixes a clip-on style terminal contact mechanism on a battery support plate. Battery holder (400) with non-conductive plastic battery support plates (405a, 405b) has multiple rubber elastic bands (406a, 406b, 406c, 406d) attached evenly to both sides of battery support plates (405a, 405b). Said battery support plates (405a, 405b) and said elastic bands (406a, 406b, 406c, 406d) are used for inserting and holding a battery (490) within. Terminal contacts (402a, 402b) are structured in clip style so that they can be attached to and removed from battery support plates (SOSa, 405b) by clipping on and off. Said terminal contact (402a) connects to a negative lead wire (407) and said terminal contact (402b) connects to a positive lead wire (408). As shown in Fig.9, said battery holder (400), upon insertion of a battery (390) between the battery support plates and the elastic bands expands the elastic bands (406a, 406b, 406c, 406d) and exerts tension between the battery support plates (505a, 405b) and a battery (390) so that the expanded battery holder maintains proper contact between battery electrodes (409a, 409b) and terminal contacts (402a, 402b). FIG. 10 shows another embodiment of the present invention which is very similar to FIG. 4 but employs a clip-on style terminal contact mechanism on a battery support plate. As shown in FIG. 10 and FIG. 11, battery holder (500) has non-conductive plastic battery support plates (505a, 505b) having multiple rubber elastic bands (506a, 506b, 506c, 506d) attached evenly to both sides of battery support plates (505a, 505b). Said battery support plates (505a, 505b) and said elastic bands (506a, 506b, 506c, 506d) are used for inserting and holding a battery (590) within. Terminal contact (502a, 502b) are structured in a clip style so that the terminal contacts can be attached to and removed from said battery support plates (505a, 505b) by clipping on and off. Terminal contact (502a) connects to a negative lead wire (507) and terminal contact (502b) connects to a positive lead wire (508). Where there is more than one terminal contact on a battery support plate, as in FIG. 10, a barrier wall can be erected between two adjacent terminal contacts to prevent shortage between battery electrodes during battery insertion and removal. The other battery support plate (505b) does not have terminal contacts and provides battery support function only. As shown in FIG. 11, said battery holder (500), upon insertion of a battery (490) between the battery support plates and the elastic bands expands the elastic bands and exerts tension between the battery support plates (505a, 505b) and a battery (490) so that the expanded battery holder maintains proper contact between battery electrodes (509a, 509b) and terminal contacts (502a, 502b).

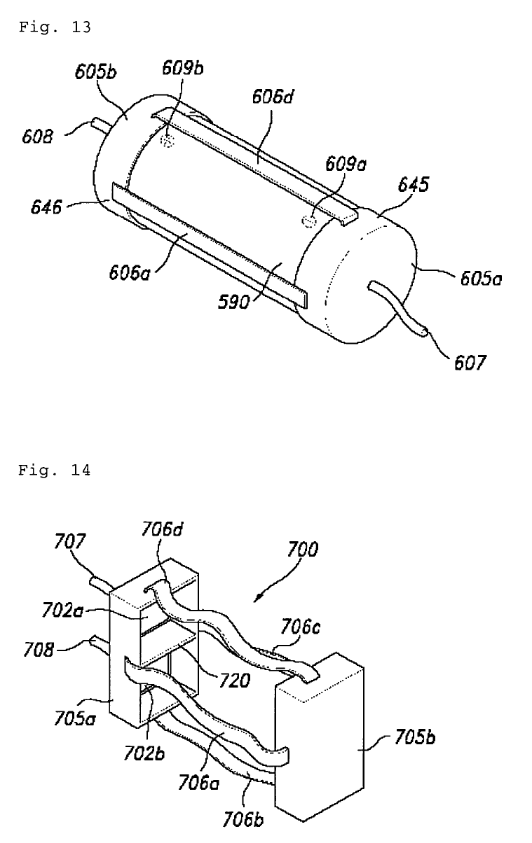

FIG. 12 shows another embodiment of the present invention which is very similar to FIG. 2 but employs a battery support plate with cylindrical wall. Battery holder (600) with non-conductive plastic battery support plates (605a, 605b) has multiple rubber elastic bands (606a, 606b, 606c, 606d) attached evenly to both sides of battery support plates (605a, 605b). Said battery support plates (605a, 605b) and said elastic bands (606a, 606b, 606c, 606d) are used for inserting and holding a battery (690) within. Said battery support plates (605a, 605b) have longitudinally extended cylindrical walls (645, 646) from the base of the plates. Terminal contact (602a) is forcefully inserted on said battery support plate (605a) and terminal contact (602b) is forcefully inserted on said battery support plate (605b). Terminal contact (602a) connects to a negative lead wire (607) penetrated through said battery support plate (605a) and terminal contact (602b) connects to a positive lead wire (608) penetrated through said battery support plate (605b). The cylindrical walls of said battery support plates (605a, 605b) can be not only circular in shape but also rectangular or other shapes. As shown in FIG. 13, said battery holder (600), upon insertion of a battery (590) between the battery support plates (605a, 605b) and said elastic bands (606a, 606b, 606c, 606d) expands the elastic bands and exerts tension between the battery support plates (605a, 605b) and the battery (590) so that the expanded battery holder maintains proper contact between battery electrodes (609a, 609b) and terminal contacts (602a, 602b). The cylindrical walls (645, 646) of said battery support plates (605a, 605b) assist the fitting of said battery (690) into said battery holder (600).

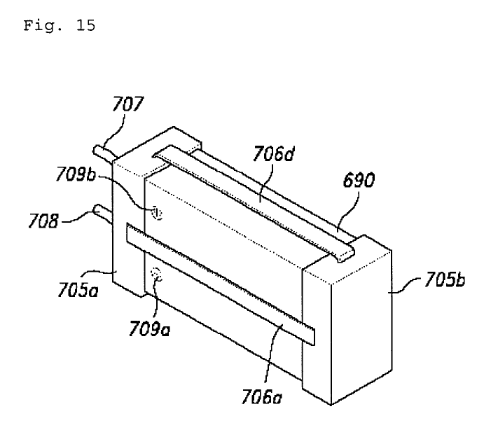

FIG. 14 shows another embodiment of the present invention which is very similar to FIG. 4 but employs a battery support plate with a rectangular wall. Battery holder (700) with non-conductive plastic battery support plates (705a, 705b) has multiple rubber elastic bands (706a, 706b, 706c, 706d) attached evenly to both sides of battery support plates (705a, 705b). Said battery support plates (705a, 705b) and said elastic bands (706a, 706b, 706c, 706d) are used for inserting and holding a battery (690) within. Said battery support plates (705a, 705b) have longitudinally extended rectangular walls (745, 746) from the base of the plates. Terminal contact (702a) is forcefully inserted on said battery support plate (705a) and terminal contact (702b) is forcefully inserted on said battery support plate (705b). Said terminal contact (702a) connects to a negative lead wire (707) penetrated through said battery support plate (705a) and said terminal contact (702b) connects to a positive lead wire (708) penetrated through said battery support plate (705b). Where there is more than one terminal contact on a battery support plate, as in FIG. 14, a barrier wall can be erected between two adjacent terminal contacts to prevent shortage between battery electrodes during the battery insertion and removal. The other battery support plate (705b) does not have any terminals. As shown in FIG. 15, said battery holder (700), upon insertion of a battery (690) between the battery support plates (705a, 705b) and said elastic bands (706a, 706b, 706c, 706d) expands the elastic bands (706a, 706b, 706c, 706d) and exerts tension between the battery support plates (705a, 705b) and a battery (690) so that the expanded battery holder maintains proper contact between battery electrodes (709a, 709b) and terminal contacts (702a, 702b). Rectangular walls (745, 746) of said battery support plates (705a, 705b) assist said battery (690) to precisely fit into said battery holder (700). This example can be used for a battery with positive and negative electrodes on one side.

The advantages achieved by the battery holder of the present invention are as follows:

1. the present invention can be collapsed into a very small space that allows carrying and storing in a very space-efficient manner since the main material of the battery holder is elastic,

2. one battery holder can house variously sized batteries if tension is properly adjusted,

3. a single battery holder can support multiple battery types with clip-on terminal contacts.

Although the present invention has been illustrated and described with reference to the preferred embodiment thereof, it should be understood that it is in no way limited to the details of such embodiment but is capable of numerous modifications within the scope of the appended claims.

What is claimed is:

1. A battery holder consisting of battery support plates with elastic bands attached to the battery support plates and extending outward as a means of holding the battery/batteries in place, with terminal contacts affixed on the battery support plates, so that the battery when inserted into the battery holder expands the elastic bands to create tension and, therefore, maintain contact between the battery electrodes and the terminal contacts.

2. A battery holder as claimed in claim 1, wherein two of said battery support plates, each with opposite terminal contacts, form one pair and are connected by the said elastic bands.

3. A battery holder as claimed in claim 1, wherein said elastic bands are attached to one battery support plate containing opposite terminal contacts in a closed loop configuration.

4. A battery holder as claimed in claim 2, wherein said elastic bands consist of multiple bands or elasticized fabrics attached around the circumference of the battery support plates.

5. A battery holder as claimed in claim 3, wherein said elastic bands consist of multiple bands or elasticized fabrics attached around the circumference of the battery support plate.

6. A battery holder as claimed in claim 2, wherein said battery support plate holds multiple terminal contacts.

7. A battery holder as claimed in claim 3, wherein said battery support plate holds multiple terminal contacts.

8. A battery holder as claimed in claim 1, wherein said battery support plate has longitudinally extended side walls to which said elastic bands are attached.

9. A battery holder as claimed in claim 2, wherein said terminal contact is affixed to a clip-on mechanism that attaches to and removes from said battery support plate.

10. A battery holder as claimed in claim 3, wherein said terminal contact is affixed to a clip-on mechanism that attaches to and removes from said battery support plate.

11. A battery holder as claimed in claim 6, wherein said battery support plate has a barrier wall between two adjacent terminal contacts.

12. A battery holder as claimed in claim 7, wherein said battery support plate has a barrier wall between two adjacent terminal contacts.
